(19) United States
(12) Patent Application Publication
(10) Pub. No.: US 2014/0194004 A1
(43) Pub. Date: Jul. 10, 2014

(54) GROUNDING STRUCTURES FOR A RECEPTACLE ASSEMBLY

(71) Applicant: TYCO ELECTRONICS CORPORATION, Berwyn, PA (US)

(72) Inventors: Justin Dennis Pickel, Hummelstown, PA (US); Alex Michael Sharf, Harrisburg, PA (US)

(73) Assignee: Tyco Electronics Corporation, Berwyn, PA (US)

(21) Appl. No.: 13/735,386

(22) Filed: Jan. 7, 2013

(51) Int. Cl. H01R 13/648

(52) U.S. Cl. CPC H01R 13/648
USPC 439/607.01

(57) ABSTRACT

A receptacle assembly includes a contact module including a holder having a first side and an opposite second side. The holder holds a plurality of contacts. The contacts extend from the holder for electrical termination. A first ground shield is coupled to the first side. The first ground shield has grounding beams extending forward of the holder for electrical connection to a header assembly. The first ground shield has ground skewers extending into the holder. A second ground shield is coupled to the second side. The second ground shield has grounding beams extending forward of the holder for electrical connection to the header assembly. The second ground shield has ground skewers extending into the holder and the frame assembly. The ground skewers of the second ground shield engage and electrically connect to corresponding ground skewers of the first ground shield.

### BACKGROUND OF THE INVENTION

The subject matter herein relates generally to grounding connector assemblies.

Some electrical systems utilize electrical connectors, such as headers and receptacles, to interconnect two circuit boards, such as a motherboard and daughtercard. In some systems, to electrically connect the electrical connectors, a midplane circuit board is provided with front and rear header connectors on opposed front and rear sides of the midplane circuit board. Other systems electrically connect the circuit boards without the use of a midplane circuit board by directly connecting electrical connectors on the circuit boards.

However, as speed and performance demands increase, known electrical connectors are proving to be insufficient. Signal loss and/or signal degradation is a problem in known electrical systems. Additionally, there is a desire to increase the density of electrical connectors to increase throughput of the electrical system, without an appreciable increase in size of the electrical connectors, and in some cases, with a decrease in size of the electrical connectors. Some known connector systems increase density by coupling multiple contact modules side by side within a single receptacle assembly. Such increase in density and/or reduction in size causes further strains on performance.

In order to address performance, some known systems utilize shielding to reduce interference between the contacts of the electrical connectors. However, the shielding utilized in known systems is not without disadvantages. For instance, electrically connecting the grounded components of the two electrical connectors at the mating interface of the electrical connectors is difficult and defines an area where signal degradation occurs due to improper shielding at the interface. For example, some known systems include ground shields on both sides of the contact modules on a receptacle assembly that connect to corresponding header contacts of the header assembly. Both ground shields are electrically connected to the header contacts at the mating zone, but the ground shields remain isolated downstream of the mating zone. The ground shields may be at different electrical potentials and the signal contacts between the two ground shields are referenced to different electrical potentials, leading to signal degradation.

A need remains for an electrical system that provides efficient shielding to meet particular performance demands. A need remains for an electrical system that electrically connects the shielding members.

### BRIEF DESCRIPTION OF THE INVENTION

In one embodiment, a receptacle assembly is provided having a contact module including a holder having a first side and an opposite second side. The holder holds a frame assembly. The frame assembly includes a plurality of contacts and a dielectric frame supporting the contacts. The dielectric frame is received in the holder. The contacts extend from the holder for electrical teimination. A first ground shield is coupled to the first side. The first ground shield has grounding beams extending forward of the holder for electrical connection to a corresponding header contact of a header assembly. The first ground shield has ground skewers extending into the holder and the frame assembly. A second ground shield is coupled to the second side. The second ground shield has grounding beams extending forward of the holder for electrical connection to a corresponding header contact of the header assembly. The second ground shield has ground skewers extending into the holder and the frame assembly. The ground skewers of the second ground shield engage and electrically connect to corresponding ground skewers of the first ground shield.

In another embodiment, a receptacle assembly is provided having a contact module including a holder having a right holder member and a left holder member. The holder holds a frame assembly having a plurality of contacts and a dielectric frame supporting the contacts. The dielectric frame is received in the holder and the contacts extending from the holder for electrical termination. A first ground shield is coupled to the right holder member and has grounding beams extending forward of the holder for electrical connection to a corresponding header contact of a header assembly. The first ground shield has ground skewers extending into the frame assembly to engage the left holder member to create an electrical path between the first ground shield and the left holder member. Optionally, a second ground shield may be coupled to the left holder member. The second ground shield may have ground skewers extending into the frame assembly to engage the right holder member and/or the ground skewers of the first ground shield.

In a further embodiment, an electrical connector assembly includes a header assembly having a header housing, a plurality of header contacts held by the header housing, and a plurality of C-shaped header contacts surrounding corresponding header contacts on three sides. The header contacts have walls defining the C-shaped header contacts. A receptacle assembly is mated to the header assembly. The receptacle assembly includes a front housing received in the header housing. Contact modules couple to the front housing. Each contact module includes a conductive holder having a first side and an opposite second side. The conductive holder holds a frame assembly. The frame assembly includes a plurality of contacts and a dielectric frame supporting the contacts. The dielectric frame is received in the conductive holder. The contacts extend from the conductive holder into the front housing for electrical termination to corresponding header contacts. A first ground shield is coupled to the first side. The first ground shield is electrically connected to the conductive holder. The first ground shield has grounding beams extending forward of the conductive holder into the front housing for electrical connection to corresponding header contacts of the header assembly. The first ground shield has ground skewers extending into the conductive holder and the frame assembly. A second ground shield is coupled to the second side. The second ground shield is electrically connected to the conductive holder. The second ground shield has grounding beams extending forward of the conductive holder into the front housing for electrical connection to corresponding header contacts of the header assembly. The second ground shield has ground skewers extending into the conductive holder and the frame assembly. The ground skewers of the second ground shield engage and electrically connect to corresponding ground skewers of the first ground shield.

### BRIEF DESCRIPTION OF THE DRAWINGS

FIG. 1 is a perspective view of an electrical connector system formed in accordance with an exemplary embodiment.

FIG. 2 is an exploded view of a receptacle assembly showing a contact module poised for loading into a front housing.

FIG. 3 is an exploded perspective view of the contact module shown in FIG. 2.

FIG. 4 is a perspective view of the right ground shield shown in FIG. 3.

FIG. 5 is a perspective view of the left ground shield shown in FIG. 3.

FIG. 6 is a front cross-sectional view of a portion of the contact module shown in FIG. 2.

FIG. 7 is a front cross-sectional view of a portion of the contact module shown in FIG. 2.

FIG. 8 is a perspective view of a ground shield formed in accordance with an exemplary embodiment.

FIG. 9 is a perspective view of a ground shield formed in accordance with an exemplary embodiment.

### DETAILED DESCRIPTION OF THE INVENTION

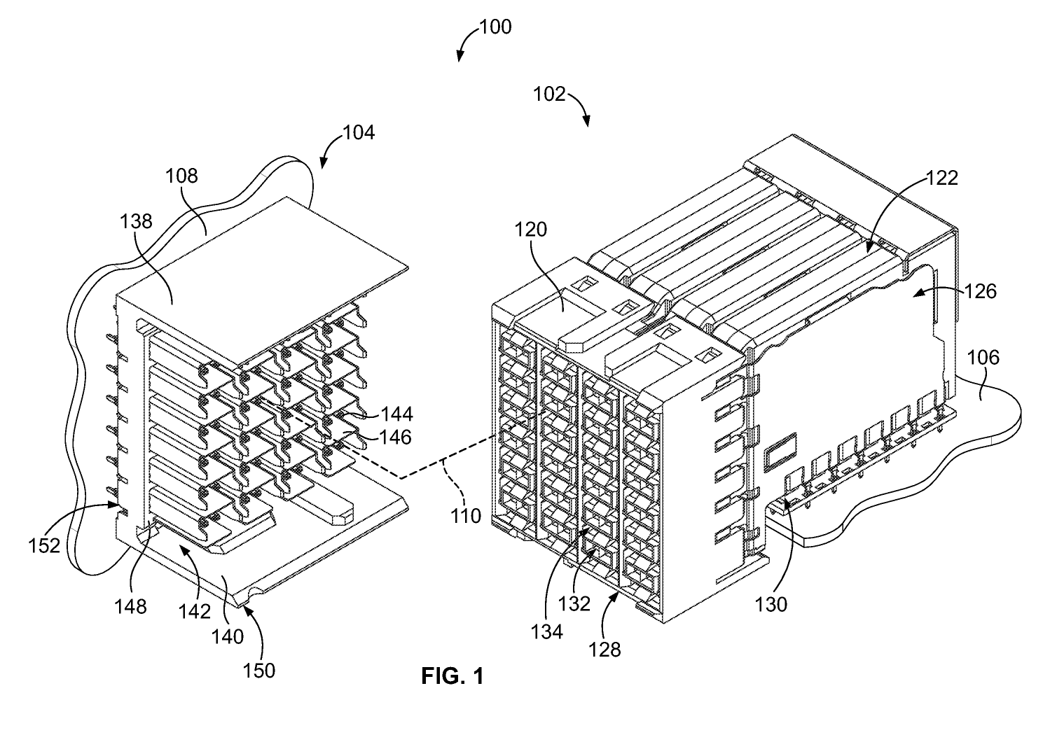

FIG. 1 is a perspective view of an electrical connector system 100 formed in accordance with an exemplary embodiment. The connector system 100 includes a receptacle assembly 102 and a header assembly 104 that may be directly mated together. The receptacle and header assemblies 102, 104 are each electrically connected to respective circuit boards 106, 108. The receptacle and header assemblies 102, 104 are utilized to electrically connect the circuit boards 106, 108 to one another at a separable mating interface. In an exemplary embodiment, the circuit boards 106, 108 are oriented perpendicular to one another when the receptacle and header assemblies 102, 104 are mated. Alternative orientations of the circuit boards 106, 108 are possible in alternative embodiments. Optionally, the receptacle and header assemblies 102, 104 may be mounted to cables and the like rather than the circuit boards 106, 108.

A mating axis 110 extends through the receptacle and header assemblies 102, 104. The receptacle and header assemblies 102, 104 are mated together in a direction parallel to and along the mating axis 110.

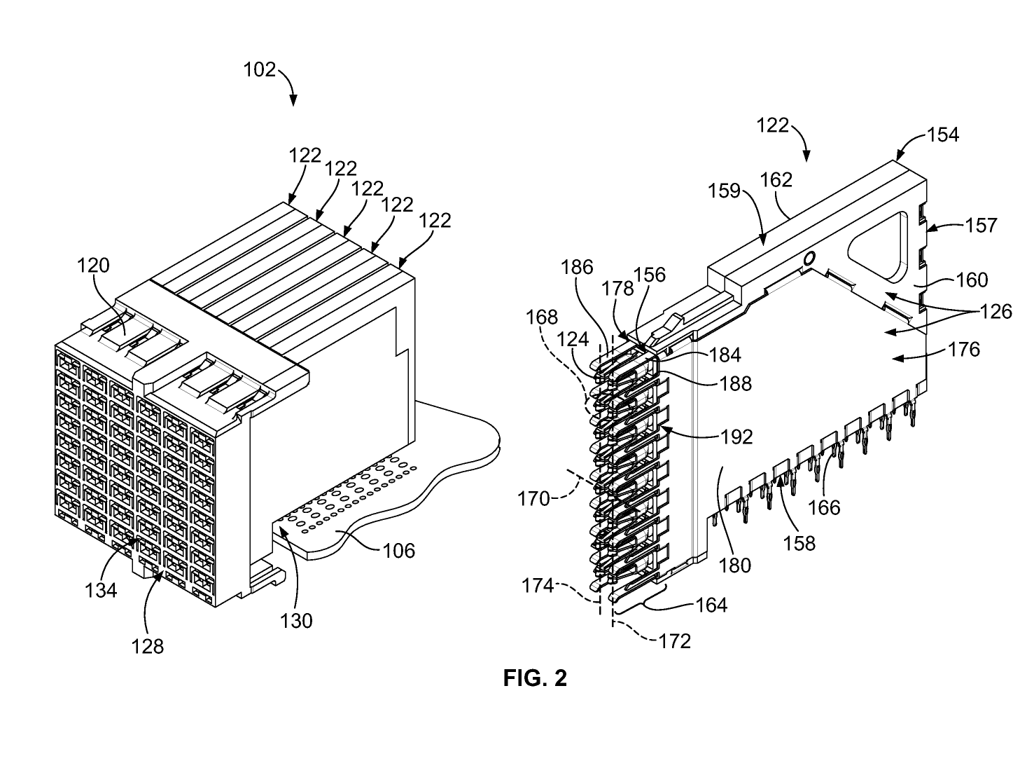

The receptacle assembly 102 includes a front housing 120 that holds a plurality of contact modules 122. The contact modules 122 are held in a stacked configuration generally parallel to one another. Any number of contact modules 122 may be provided in the receptacle assembly 102. The contact modules 122 each include a plurality of receptacle signal contacts 124 (shown in FIG. 2) that define signal paths through the receptacle assembly 102.

The receptacle assembly 102 includes a mating end 128 and a mounting end 130. The receptacle signal contacts 124 (shown in FIG. 2) are received in the front housing 120 and held therein at the mating end 128 for electrical termination to the header assembly 104. The receptacle signal contacts 124 are arranged in a matrix of rows and columns. In the illustrated embodiment, at the mating end 128, the rows are oriented horizontally and the columns are oriented vertically. Other orientations are possible in alternative embodiments. Any number of receptacle signal contacts 124 may be provided in the rows and columns. Optionally, the receptacle signal contacts 124 may be arranged in pairs carrying differential signals. The receptacle signal contacts 124 extend through the receptacle assembly 102 from the mating end 128 to the mounting end 130 for mounting to the circuit board 106. Optionally, the mounting end 130 may be oriented substantially perpendicular to the mating end 128.

In an exemplary embodiment, each contact module 122 has a shield structure 126 for providing electrical shielding for the receptacle signal contacts 124. The contact modules 122 may generally provide 360° shielding for each pair of receptacle signal contacts 124 along substantially the entire length of the receptacle signal contacts 124 between the mounting end 130 and the mating end 128. In an exemplary embodiment, the shield structure 126 is electrically connected to the header assembly 104 and/or the circuit board 106. For example, the shield structure 126 may be electrically connected to the header assembly 104 by extensions (e.g. beams and/or fingers) extending from the contact modules 122 that engage the header assembly 104. The shield structure 126 may be electrically connected to the circuit board 106 by features, such as ground pins. In an exemplary embodiment, a portion of the shield structure 126 on one side of the contact module 122 is electrically connected to a portion of the shield structure 126 on another side of the contact module 122. For example, portions of the shield structure 126 on opposite sides of the contact module 122 may be electrically connected to each other by internal extensions (e.g. skewers) that extend through the interior of the contact module 122. Having the shield structure 126 on opposite sides of the contact module 122 electrically connected to each other electrically commons the shield structure 126 to provide increased performance of the signal transmission through the contact module 122.

The front housing 120 includes a plurality of signal contact openings 132 and a plurality of ground contact openings 134 at the mating end 128. The receptacle signal contacts 124 are received in corresponding signal contact openings 132. Optionally, a single receptacle signal contact 124 is received in each signal contact opening 132. The signal contact openings 132 may also receive corresponding header signal contacts 144 therein when the receptacle and header assemblies 102, 104 are mated. The ground contact openings 134 receive header contacts 146 therein when the receptacle and header assemblies 102, 104 are mated. The ground contact openings 134 also receive the extensions (e.g. beams and/or fingers) of the shield structure 126 of the contact modules 122 that mate with the header contacts 146 to electrically common the receptacle and header assemblies 102, 104.

The front housing 120 is manufactured from a dielectric material, such as a plastic material, and provides isolation between the signal contact openings 132 and the ground contact openings 134. The front housing 120 isolates the receptacle signal contacts 124 and the header signal contacts 144 from the header contacts 146. The front housing 120 isolates each set of receptacle and header signal contacts 124, 144 from other sets of receptacle and header signal contacts 124, 144.

The header assembly 104 includes a header housing 138 having walls 140 defining a chamber 142. The header assembly 104 has a mating end 150 and a mounting end 152 that is mounted to the circuit board 108. Optionally, the mounting end 152 may be substantially parallel to the mating end 150. The receptacle assembly 102 is received in the chamber 142 through the mating end 150. The front housing 120 engages the walls 140 to hold the receptacle assembly 102 in the chamber 142. The header signal contacts 144 and the header contacts 146 extend from a base wall 148 into the chamber 142. The header signal contacts 144 and the header contacts 146 extend through the base wall 148 and are mounted to the circuit board 108.

The header contacts 146 provide electrical shielding around corresponding header signal contacts 144. The header signal contacts 144 may be arranged in rows and columns on the header assembly 104. In an exemplary embodiment, the header signal contacts 144 are arranged in pairs configured to convey differential signals. The header contacts 146 peripherally surround a corresponding pair of the header signal contacts 144 to provide electrical shielding. In the illustrated embodiment, the header contacts 146 are C-shaped, covering three sides of the pair of header signal contacts 144. In the illustrated embodiment, the header contacts 146 have three walls defining the C-shape and an open bottom, with the header contact 146 below the open bottom providing shielding across the open bottom. Each pair of header signal contacts 144 is therefore surrounded on all four sides thereof using the C-shaped header contact 146 and the header contact 146 below the pair of header signal contacts 144. Therefore, each of the pairs of header signal contacts 144 is shielded from adjacent pairs in the same column and the same row. Other configurations or shapes for the header contacts 146 are possible in alternative embodiments. In other embodiments, the header contacts 146 may provide shielding for individual signal contacts 144 or sets of contacts having more than two signal contacts 144.

FIG. 2 is an exploded view of the receptacle assembly 102 showing one of the contact modules 122 poised for loading into the front housing 120. The contact modules 122 may be loaded side-by-side and parallel to each other in a stacked configuration. Six contact modules 122 are illustrated in FIG. 2, but any number of contact modules 122 may be used in alternative embodiments.

The contact module 122 includes a conductive holder 154 which defines at least a portion of the shield structure 126. The conductive holder 154 generally surrounds the receptacle signal contacts 124 along substantially the entire length of the receptacle signal contacts 124 between the mounting end 130 and the mating end 128. The conductive holder 154 has a front 156 configured to be loaded into the front housing 120, a rear 157 opposite the front 156, a bottom 158 which optionally may be adjacent to the circuit board 106, and a top 159 generally opposite the bottom 158. The conductive holder 154 also defines right and left exterior sides 160, 162.

The conductive holder 154 is fabricated from a conductive material which provides electrical shielding for the receptacle assembly 102. For example, the conductive holder 154 may be die-cast, or alternatively stamped and formed, from a metal material. In other alternative embodiments, the holder 154 may be fabricated from a plastic material that has been metalized or coated with a metallic layer.

The receptacle signal contacts 124 have mating portions 164 extending forward from the front 156 of the conductive holder 154. The mating portions 164 are configured to be electrically terminated to corresponding header signal contacts 144 (shown in FIG. 1) when the receptacle assembly 102 and header assembly 104 (shown in FIG. 1) are mated. In an exemplary embodiment, the other ends of the receptacle signal contacts 124 extend downward from the bottom 158 of the conductive holder 154 as contact tails 166. The contact tails 166 electrically connect the contact module 122 to the circuit board 106. The contact tails 166 may be configured as ground pins. In an exemplary embodiment, the mating portions 164 extend generally perpendicular with respect to the contact tails 166.

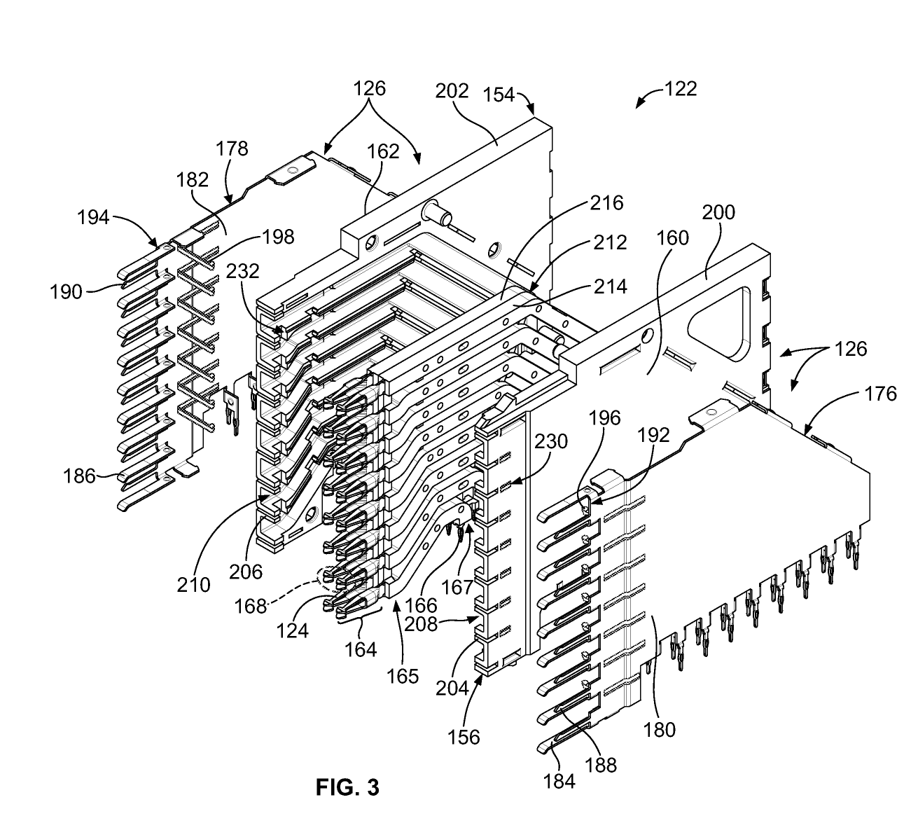

Inner portions or encased portions of the receptacle signal contacts 124 transition between the mating portions 164 and the contact tails 166 within the conductive holder 154. A first transition area 165 (shown in FIG. 3) of the receptacle signal contacts 124 may be located within the conductive holder 154 proximate to the mating portions 164. In the illustrated embodiment, the first transition area 165 may be a region generally interior of the front 156 of the conductive holder 154 where the receptacle signal contacts 124 diverge from an orientation parallel to the mating portions 164. A second transition area 167 (shown in FIG. 3) may be located within the conductive holder 154 proximate to the contact tails 166. The second transition area 167 may be a region generally interior of the bottom 158 of the conductive holder 154 where the receptacle signal contacts 124 diverge from an orientation parallel to the contact tails 166.

In an exemplary embodiment, the receptacle signal contacts 124 in each contact module 122 are arranged as contact pairs 168 configured to transmit differential signals through the contact module 122. The receptacle signal contacts 124 within each contact pair 168 are arranged in rows that extend along row axes 170. In an exemplary embodiment, each row axis 170 includes one contact pair 168 from each contact module 122 stacked together in the receptacle assembly 102. At the mating end 128, the contact pairs 168 within each contact module 122 are stacked vertically. The right receptacle signal contacts 124 of each contact module 122 extend along a column axis 172, and the left receptacle signal contacts 124 of each contact module extend along a column axis 174. When the contact modules 122 are stacked in the receptacle assembly 102, the column axes 172, 174 of the contact modules 122 extend parallel to each other.

In an exemplary embodiment, each contact module 122 includes first and second ground shields 176, 178, which define at least a portion of the shield structure 126. The ground shields 176, 178 may be positioned along the exterior sides 160, 162 of the conductive holder 154. For example, the first ground shield 176 may be positioned along the right side 160 of the conductive holder 154, and as such, may be hereinafter referred to as the right ground shield 176. The second ground shield 178 may be positioned along the left side 162 of the conductive holder, and may be hereinafter referred to as the left ground shield 178. The ground shields 176, 178 are configured to provide electrical shielding for the receptacle signal contacts 124. The ground shields 176, 178 electrically connect the contact module 122 to the header contacts 146 (shown in FIG. 1), which electrically commons the connection across the receptacle assembly 102 and header assembly 104 (shown in FIG. 1).

The right ground shield 176 is coupled to the right exterior side 160 of the conductive holder 154. When attached to the conductive holder 154, the right ground shield 176 electrically connects to the conductive holder 154. The right ground shield 176 includes a main body 180 that is generally planar and extends alongside of the conductive holder 154. The ground shield 176 includes grounding beams 184 and grounding fingers 188 extending from a front 192 of the main body 180. The ground shield 176 also includes ground skewers 196 (shown in FIG. 3) extending inward from the planar main body 180.

The grounding beams 184 may be bent inward out of plane with respect to the main body 180 such that the grounding beams 184 are oriented perpendicular with respect to the plane defined by the main body 180. The grounding beams 184 are bent inward toward the holder 154. In an exemplary embodiment, the grounding fingers 188 are arranged generally in the plane defined by the main body 180, though the grounding fingers 188 may be bent out of plane in alternative embodiments. Optionally, the main body 180 and the grounding fingers 188 may extend vertically while the grounding beams 184 may extend horizontally. Other orientations are possible in alternative embodiments. Any number of grounding beams 184 and grounding fingers 188 may be provided.

The left ground shield 178 may be similar to the right ground shield 176. The left ground shield 178 may be a mirrored version of the right ground shield 176. The left ground shield 178 is coupled to the left exterior side 162 of the conductive holder 154. The left ground shield 178 includes a main body 182 (shown in FIG. 3) that is generally planar and extends alongside of the conductive holder 154. The ground shield 178 includes grounding beams 186 and grounding fingers 190 (shown in FIG. 3) extending from a front 194 (shown in FIG. 3) of the main body 182. The ground shield 178 also includes ground skewers 198 (shown in FIG. 3) extending inward from the planar main body 182.

In an exemplary embodiment, the right and left ground shields 176, 178 are manufactured from a metal material. The ground shields 176, 178 are stamped and formed parts with the grounding fingers 188, 190 being stamped and the grounding beams 184, 186 being stamped and then bent out of plane with respect to the main bodies 180, 182 during the forming process.

In the contact module 122, the grounding beams 184, 186 of the ground shields 176, 178 extend forward from the front 156 of the conductive holder 154 and are configured to provide shielding for the receptacle signal contacts 124 along the mating portions 164. As illustrated, the grounding beams 184, 186 may be aligned with the receptacle signal contact pairs 168 along the column axis 172 and the column axis 174, respectively. Each of the contact pairs 168 is shielded both above and below its respective row axis 170 by corresponding grounding beams 184, 186.

The grounding beams 184, 186 and grounding fingers 188, 190 are configured to engage and be electrically connected to the header contacts 146 (shown in FIG. 1) of the header assembly 104 (shown in FIG. 1) to electrically common the receptacle assembly 102 and the header assembly 104 upon mating. The right and left ground shields 176, 178 provide multiple, redundant points of contact to the header contacts 146. For example, upon mating the receptacle assembly 102 and header assembly 104, each header contact 146 may be engaged by two grounding beams 184, 186 and two grounding fingers 188, 190.

FIG. 3 illustrates an exploded perspective view of the contact module 122. The conductive holder 154 shown in the illustrated embodiment includes a right holder member 200 and a left holder member 202. Upon assembling the contact module 122, the right and left holder members 200, 202 are coupled together to form the conductive holder 154. The right and left ground shields 176, 178 are coupled to the right and left holder members 200, 202, respectively. The right ground shield 176 engages and is electrically connected to the right holder member 200. The left ground shield 178 engages and is electrically connected to the left holder member 202. The skewers 196, 198 extend through the holder members 200, 202 to engage each other to electrically common the right and left ground shields 176, 178, and thus the right and left holder members 200, 202.

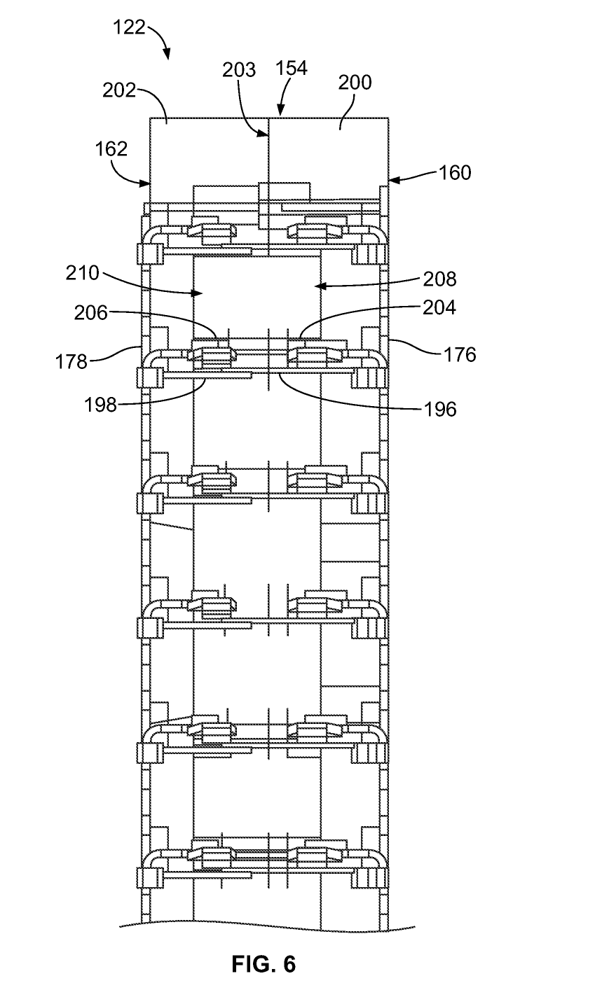

The right holder member 200 interfaces the left holder member 202 at a seam 203 (shown in FIG. 6). The holder members 200, 202 include tabs 204, 206 that extend inward toward one another to define discrete channels 208, 210, respectively. The tabs 204, 206 define at least a portion of the shield structure 126 that provides electrical shielding for the receptacle signal contacts 124.

As a part of the shield structure 126, the holder members 200, 202 generally provide electrical shielding between and around respective receptacle signal contacts 124. For example, the holder members 200, 202 provide shielding from electromagnetic interference (EMI) and/or radio frequency interference (RFI), and may provide shielding from other types of interference as well. The holder members 200, 202 may provide shielding around the outside of the receptacle signal contacts 124 as well as between the receptacle signal contacts 124 using the tabs 204, 206. As a result, the holder members 200, 202 allow for better control of electrical characteristics, such as impedance, cross-talk, and the like, of the receptacle signal contacts 124.

The conductive holder 154 holds a frame assembly 212, which includes the receptacle signal contacts 124. Upon assembly of the contact module 122, the frame assembly 212 is received in the channels 208, 210 of the right and left holder members 200, 202. The holder members 200, 202 provide shielding around the frame assembly 212 and receptacle signal contacts 124. The tabs 204, 206 are configured to extend into the frame assembly 212 such that the tabs are positioned between receptacle signal contact pairs 168 to provide shielding between adjacent contact pairs 168. In alternative embodiments, one holder member 200 or 202 could have a tab that accommodates the entire frame assembly 212 and the other holder member 200 or 202 acts as a lid.

The frame assembly 212 includes a pair of right and left dielectric frames 214, 216, respectively, surrounding and supporting the receptacle signal contacts 124. In an exemplary embodiment, one of the receptacle signal contacts 124 of each contact pair 168 is held by the right dielectric frame 214, while the other receptacle signal contact 124 of the contact pair 168 is held by the left dielectric frame 216. The receptacle signal contacts 124 of each contact pair 168 extend through the frame assembly 212 generally along parallel paths such that the receptacle signal contacts 124 are skewless between the mating portions 164 and the contact tails 166.

In an exemplary embodiment, the receptacle signal contacts 124 are initially held together as leadframes (not shown), which are overmolded with dielectric material to form the dielectric frames 214, 216. Manufacturing processes other than overmolding a leadframe may be utilized to form the dielectric frames 214, 216, such as loading receptacle signal contacts 124 into a formed dielectric body.

The ground skewers 196, 198 extend from the main bodies 180, 182 of the right and left ground shields 176, 178 toward the interior of the contact module 122. In an exemplary embodiment, the right ground skewers 196 extend inward such that the ground skewers 196 are oriented generally perpendicular to the plane defined by the main body 180. The left ground skewers 198 extend inward such that the ground skewers 198 are oriented generally perpendicular to the plane defined by the main body 182.

During assembly, the right ground shield 176 is coupled to the right exterior side 160 of the conductive holder 154 and the left ground shield 178 is coupled to the left exterior side 162 of the conductive holder 154. The ground shields 176, 178 optionally may include mounting projections that engage the holder members 200, 202 to provide an interference fit to secure the ground shields 176, 178 to the holder members 200, 202. The conductive holder 154 includes right and left windows 230, 232 located on the right and left sides 160, 162 of the conductive holder 154. The right windows 230 extend through the right holder member 200, and the left windows 232 extend through the left holder member 202. Upon coupling the ground shields 176, 178 to the conductive holder 154, the ground skewers 196, 198 are received in the respective windows 230, 232 and extend into the conductive holder 154 and the frame assembly 212.

In an exemplary embodiment, the ground skewers 196, 198 extend through the respective holder members 200, 202 and into the frame assembly 212 where the right and left ground skewers 196, 198 engage and electrically connect. The ground skewers 196, 198 provide an electrical path between the right and left ground shields 176, 178, which commons the right and left halves of the contact module 122. In addition, the ground skewers 196, 198 may be configured to engage in such a way that the engagement holds the right and left ground shields 176, 178 firmly against the conductive holder 154, supporting the assembled structure of the contact module 122.

In an exemplary embodiment, the ground skewers 196, 198 extend into the frame assembly 212 such that the ground skewers 196, 198 are disposed between adjacent receptacle signal contact pairs 168. The ground skewers 196, 198 are offset from the receptacle signal contacts 124 in order to pass between the receptacle signal contacts 124. Any number of ground skewers 196, 198 may be provided in order to establish multiple redundant points of contact between the right and left ground shields 176, 178. In an exemplary embodiment, the ground skewers 196, 198 are vertically spaced along the respective ground shields 176, 178 proximate to the fronts 192, 194 of the ground shields 176, 178. Other positions are possible in alternative embodiments, such as along the bottoms of the ground shields 176, 178 or elsewhere. Optionally, the right and left ground skewers 196, 198 may be of substantially equal length and both extend into the contact module 122. Alternatively, the ground skewers 196, 198 may be of unequal length. For example, the right ground skewer 196 may extend all the way through the interior of the contact module and engage the corresponding left ground shield 178.

In an exemplary embodiment, the ground skewers 196, 198 are configured to span across the receptacle signal contact pairs 168 at a location proximate to the first transition area 165 near the mating portions 164. The windows 230, 232 on the conductive holder 154 may be positioned proximate to the front 156 of the conductive holder 154. The windows 230, 232 provide a pathway for the skewers 196, 198 into the frame assembly 212. The windows 230, 232 may be vertically aligned with the tabs 204, 206 of the conductive holder 154, thus forming windows in the tabs 204, 206, since the tabs 204, 206 are generally positioned between receptacle signal contact pairs 168.

In an alternative embodiment, rather than using two ground shields 176, 178, the contact module 122 may include only one ground shield, such as the right ground shield 176. The ground skewers 196 may extend into the frame assembly 212 to engage the left holder member 202 to create an electrical path between the first ground shield 176 and the left holder member 202. The first ground shield 176 may directly engage and be electrically connected to the right holder member 200. The left holder member 202 may be electrically connected to the right holder member 200, at least in part, via the ground skewers 196.

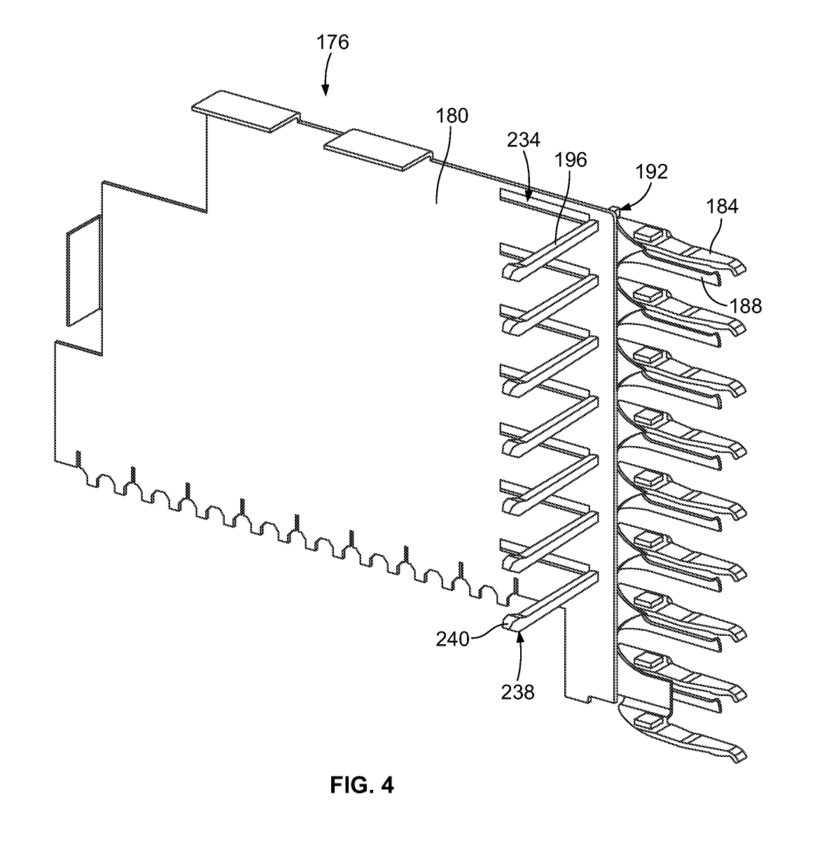

FIG. 4 is a perspective view of the right ground shield 176. In the illustrated embodiment, the ground skewers 196 are formed by stamping the main body 180 and then bending the ground skewers 196 out of plane with respect to the main body 180. The ground skewers 196 may be bent out of the main body 180 such that the ground skewers 196 extend generally perpendicular to the plane defined by the main body 180 in a direction towards the interior of the contact module 122 (shown in FIG. 2). The ground skewers 196 may be stamped and formed such that each ground skewer 196 leaves an elongated window 234 in the main body 180 when the ground skewer 196 is bent out of plane. In an alternative embodiment, the ground skewers 196 may be formed by attaching the skewers 196 to the main body 180, such as by welding or using adhesive, instead of stamping and forming the skewers 196 out of the main body 180.

In the illustrated embodiment, the ground skewers 196 are stamped and formed such that the elongated windows 234 are elongated in a direction parallel to the receptacle signal contacts 124 (shown in FIG. 3). The ground skewers 196 may be spaced vertically along the height of the main body 180. Stamping the ground skewers 196 parallel to the receptacle signal contacts 124 may allow the ground skewers 196 to be longer than stamping the ground skewers 196 in a vertical direction and folding the skewers 196 downward or upward as the overall height of the ground shield 176 is restricted and the receptacle signal contacts 124 are tightly spaced in the vertical direction. In an exemplary embodiment, the ground skewers 196 are stamped in a region near the front 192 of the main body 180. The ground skewers 196 are positioned generally at the first transition area 165 (shown in FIG. 3) of the receptacle signal contacts 124, which may be an area of geometric transition of the receptacle signal contacts 124. For example, the receptacle signal contacts 124 may start to be folded or twisted at the first transition area 165, causing changes in the interaction of the receptacle signal contacts 124 with each other and with the ground shields 176, 178. Bringing the ground skewers 196 in the vicinity of the receptacle signal contacts 124 at such transition zones may improve the electrical performance of the signal transmission through the contact module 122.

The ground skewers 196 have mating interfaces 238 at distal ends thereof. Each ground skewer 196 may include a protrusion 240 proximate to the distal end that defines the mating interface 238. The mating interfaces 238 are configured to engage at least one of the frame assembly 212, the conductive holder 154, and the corresponding left ground skewers 198 (all shown in FIG. 3). The mating interfaces 238 may be formed as part of a stamping and forming process that creates the ground skewers 196 out of the ground shield 176 or as part of another process, such as a swaging process.

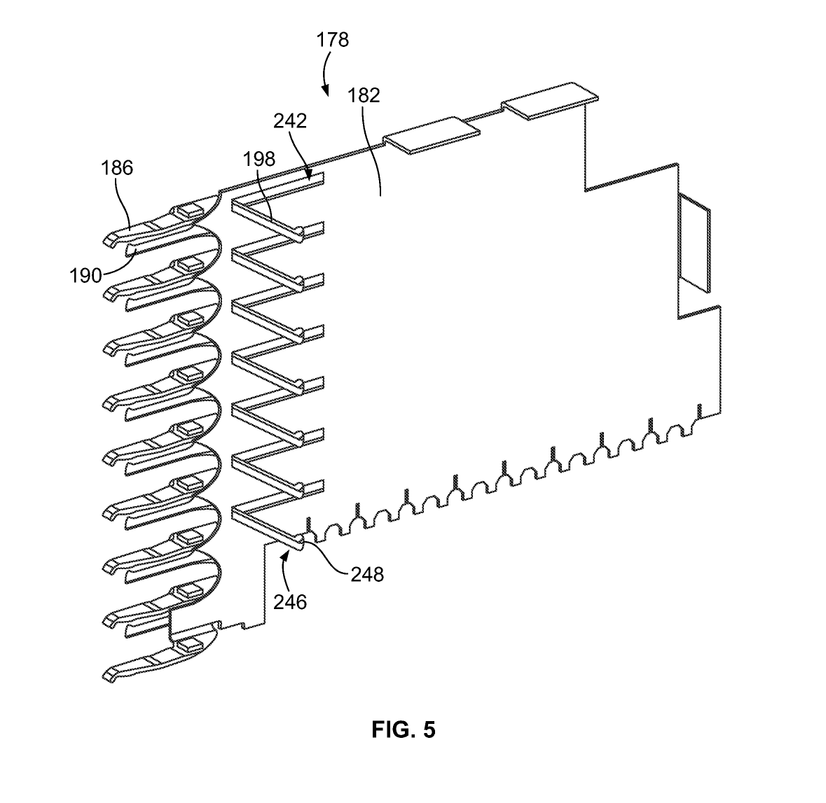

FIG. 5 is a perspective view of the left ground shield 178. The left ground shield 178 may be substantially similar to, and generally mirror, the right ground shield 176 (shown in FIG. 4). The left ground skewers 198 may be formed by stamping the main body 182 and then bending the ground skewers 198 out of the plane of the main body 182. The ground skewers 198 may be stamped and formed such that each ground skewer 198 leaves an elongated window 242 in the main body 182.

The ground skewers 198 may have mating interfaces 246 at distal ends thereof. Each ground skewer 198 may include a protrusion 248 proximate to the distal end that defines the mating interface 246. The mating interfaces 246 are configured to engage at least one of the frame assembly 212, the conductive holder 154, and the corresponding right ground skewers 196 (all shown in FIG. 3).

FIG. 6 is a front cross-sectional view of a portion of the contact module 122. When the contact module 122 is assembled, the right holder member 200 interfaces the left holder member 202 at the seam 203. The seam 203 is at least partially defined at the interfaces of corresponding right and left tabs 204, 206. The right channels 208 align horizontally with the left channels 210 to house the corresponding receptacle signal contact pairs 168 (shown in FIG. 3) held in the frame assembly 212 (shown in FIG. 3).

The right ground shield 176 is coupled to the right side 160 of the conductive holder 154 and the left ground shield 178 is coupled to the left side 162 of the conductive holder 154. The right ground skewers 196 extend through the right holder member 200 at least partially into the frame assembly 212 (shown in FIG. 3). The left ground skewers 198 extend through the left holder member 202 at least partially into the frame assembly 212. Optionally, the right ground skewer 196 may extend across the seam 203 and the left ground skewers 198 may extend across the seam 203. In an exemplary embodiment, the right and left ground skewers 196, 198 extend into the frame assembly 212 such that the ground skewers 196, 198 overlap and engage each other, creating a direct electrical path connecting the right and left ground shields 176, 178.

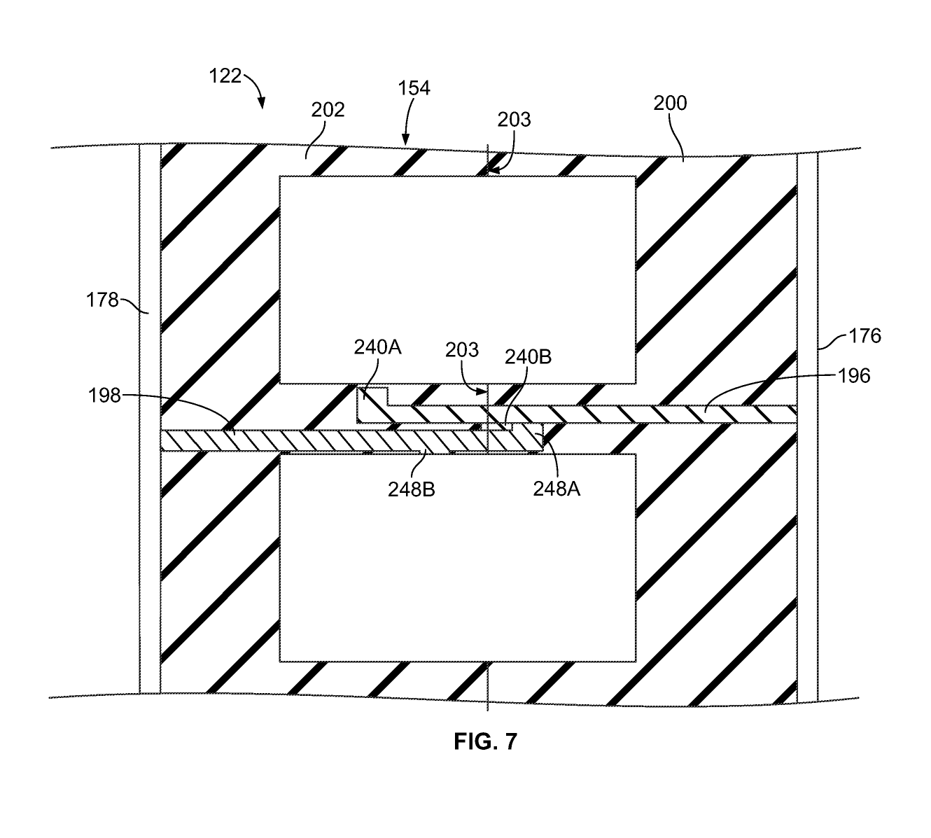

FIG. 7 is a front cross-sectional view of a portion of the contact module 122. The illustrated embodiment shows a close-up view of a section of the embodiment illustrated in FIG. 6. The right and left ground skewers 196, 198 extend through respective right and left holder members 200, 202. The ground skewers 196, 198 at least partially overlap.

In the illustrated embodiment, the protrusion 240A at the distal end of the skewer 196 extends in a direction towards the top 159 (shown in FIG. 2) of the conductive holder 154 to engage the conductive holder 154 to position the skewer 196 within the contact module. The protrusion 240B extends toward the skewer 198 to engage the skewer 198. The protrusion 248A of the skewer 198 extends toward the skewer 196 to engage the skewer 196. The skewer 198 may include another protrusion 248B located near but not at the distal end that extends downward to engage the conductive holder 154 to bias the skewer 198 toward the skewer 196. When the ground skewers 196, 198 engage, an electrical path is created through the contact module 122 that electrically commons the right and left ground shields 176, 178. To ensure that the electrical connection is maintained, the ground skewers 196, 198 may be spring biased against each other.

The pathways through the holder members 200, 202 that accommodate the ground skewers 196, 198 may be narrow with only a slight clearance around the ground skewers 196, 198. The narrow pathways support the skewers 196, 198 to position the skewers 196, 198 relative to the frame assembly 212 and each other. The narrow pathways reduce the amount of shielding area lost to accommodate the ground skewers 196, 198, so shielding effectiveness is not significantly reduced.

The ground skewers 196, 198 may also be configured to provide structural stability to the contact module 122 by providing forces that oppose the separation and disassembly of the contact module 122. For example, the skewers 196, 198 may engage each other or other elements within the contact module 122 to hold the ground shields 176, 178 against the respective holder members 200, 202 and to hold the holder members 200, 202 against each other at the seam 203. The protrusions 2408, 248A may provide a latching function once the ground skewers 196, 198 overlap, which holds the right and left ground skewers 196, 198 together.

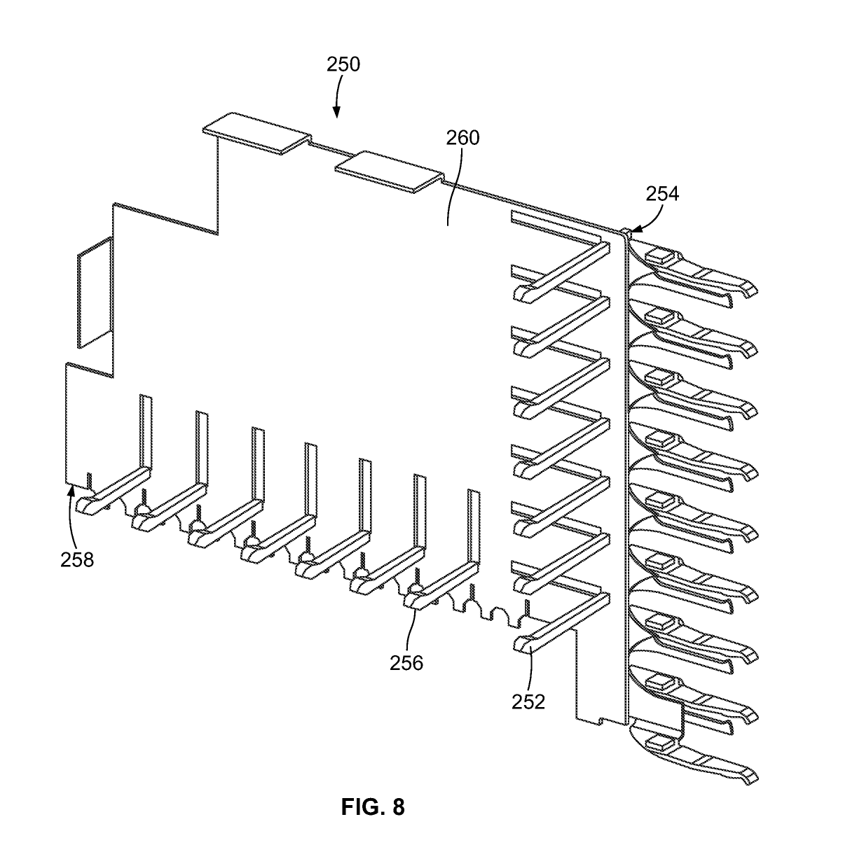

FIG. 8 is a perspective view of a ground shield 250 formed in accordance with an exemplary embodiment. The ground shield 250 may be used in place of the ground shield 176 (shown in FIG. 4). The ground shield 250 includes ground skewers 252 proximate to a front 254 of the ground shield 250, which may be similar to the ground skewers 196 (shown in FIG. 4), and ground skewers 256 proximate to a bottom 258 of the ground shield 250. In the illustrated embodiment, the ground skewers 252, 256 are stamped and formed out of a main body 260 of the ground shield 250. The ground skewers 256 are spaced horizontally along the width of the ground shield 250.

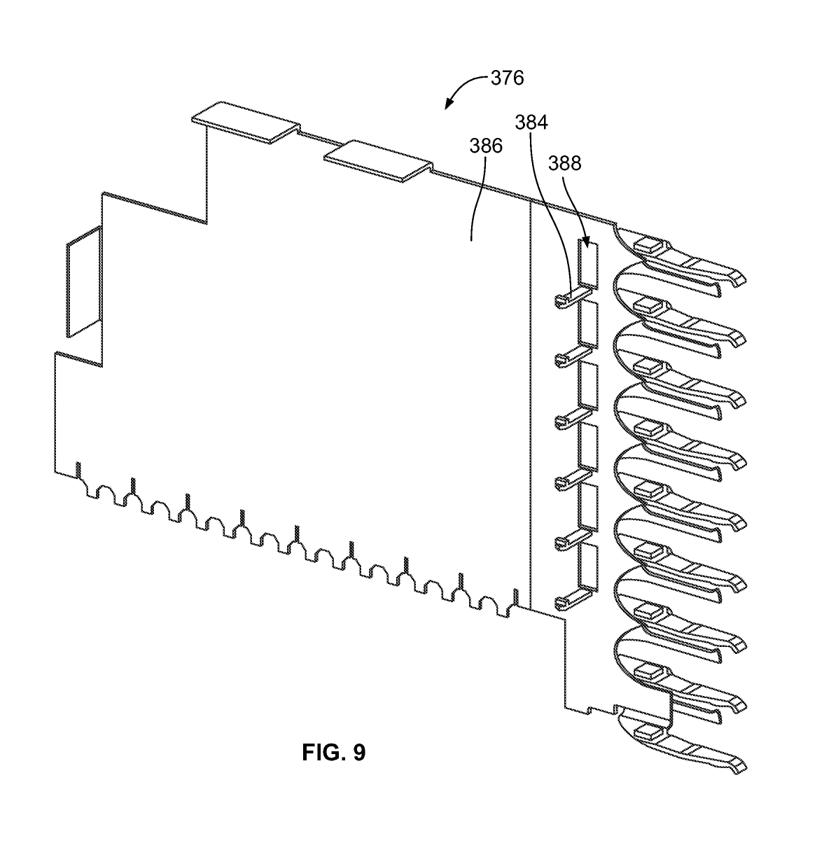

FIG. 9 is a perspective view of a ground shield 376 formed in accordance with an exemplary embodiment. The ground shield 376 may be similar to ground shield 176 (shown in FIG. 4). The ground shield 376 may be used in place of the ground shield 176. The ground shield 376 is stamped and formed out of a conductive material with ground skewers 384 stamped and formed out of a planar main body 386 of the ground shield 376.

The ground skewers 384 may be stamped and formed such that each skewer 384 leaves an elongated window 388 in the main body 386 when the skewer 384 is bent out of the plane defined by the main body 386. The skewers 384 are stamped and bent vertically such that the elongated windows 388 are elongated in a direction perpendicular to the mating portions 164 of the receptacle signal contacts 124 (both shown in FIG. 3).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A receptacle assembly comprising:
a contact module comprising a holder having a first side and an opposite second side, the holder holding a frame assembly, the frame assembly comprising a plurality of contacts and a dielectric frame supporting the contacts, the dielectric frame being received in the holder, the contacts extending from the holder for electrical termination;
a first ground shield coupled to the first side, the first ground shield having grounding beams extending forward of the holder for electrical connection to a corresponding header contact of a header assembly, the first ground shield having ground skewers extending into the holder and the frame assembly; and
a second ground shield coupled to the second side, the second ground shield having grounding beams extending forward of the holder for electrical connection to a corresponding header contact of the header assembly, the second ground shield having ground skewers extending into the holder and the frame assembly, the ground skewers of the second ground shield engaging and being electrically connected to corresponding ground skewers of the first ground shield.

2. The receptacle assembly of claim 1, wherein the ground skewers extend into the frame assembly such that the ground skewers at least partially overlap.

3. The receptacle assembly of claim 1, wherein the ground skewers of the first ground shield are spring biased against the ground skewers of the second ground shield.

4. The receptacle assembly of claim 1, wherein the ground skewers create an electrical path between the first ground shield and the second ground shield.

5. The receptacle assembly of claim 1, wherein the ground skewers are disposed between the contacts.

6. The receptacle assembly of claim 1, wherein the contacts have transitions, the ground skewers spanning across the contacts proximate to the transitions.

7. The receptacle assembly of claim 1, wherein the first ground shield includes a generally planar main body, the ground skewers being stamped out of the main body, the ground skewers being bent out of the main body such that the ground skewers extend generally perpendicular to the main body.

8. The receptacle assembly of claim 1, wherein the ground skewers engage the dielectric frame to position the ground skewers relative to the dielectric frame.

9. The receptacle assembly of claim 1, wherein the first ground shield includes a main body, the ground skewers being stamped and formed out of the main body leaving elongated windows in the main body, the windows being elongated in a direction parallel to the contacts.

10. The receptacle assembly of claim 1, wherein the contacts are stacked vertically, the ground skewers being vertically offset from the contacts and disposed between adjacent contacts.

11. A receptacle assembly comprising:
a contact module comprising a holder having a right holder member and a left holder member, the holder holding a frame assembly, the frame assembly comprising a plurality of contacts and a dielectric frame supporting the contacts, the dielectric frame being received in the holder, the contacts extending from the holder for electrical termination;
a first ground shield coupled to the right holder member, the first ground shield having grounding beams extending forward of the holder for electrical connection to a corresponding header contact of a header assembly, the first ground shield having ground skewers extending into the frame assembly to engage the left holder member to create an electrical path between the first ground shield and the left holder member.

12. The receptacle assembly of claim 11, wherein the first ground shield directly engages and is electrically connected to the right holder member, the left holder member being electrically connected to the right holder member, at least in part, via the ground skewers.

13. The receptacle assembly of claim 11, further comprising a second ground shield coupled to the left holder member, the second ground shield having grounding beams extending forward of the holder for electrical connection to a corresponding header contact of a header assembly, the second ground shield having ground skewers extending into the frame assembly to engage the right holder member to create an electrical path between the second ground shield and the right holder member.

14. The receptacle assembly of claim 11, further comprising a second ground shield coupled to the left holder member, the second ground shield having ground skewers extending into the frame assembly to engage the ground skewers of the first ground shield to create an electrical path between the first ground shield and the second ground shield.

15. The receptacle assembly of claim 11, wherein the first ground shield includes a generally planar main body, the ground skewers being stamped out of the main body, the ground skewers being bent out of the main body such that the ground skewers extend generally perpendicular to the main body.

16. An electrical connector assembly comprising:
a header assembly comprising a header housing, a plurality of header contacts held by the header housing, and a plurality of C-shaped header contacts surrounding corresponding header contacts on three sides, the header contacts having walls defining the C-shaped header contacts; and
a receptacle assembly mated to the header assembly, the receptacle assembly comprising:
a front housing received in the header housing; and
contact modules coupled to the front housing, each contact module comprising:
a conductive holder having a first side and an opposite second side, the conductive holder holding a frame assembly, the frame assembly comprising a plurality of contacts and a dielectric frame supporting the contacts, the dielectric frame being received in the conductive holder, the contacts extending from the conductive holder into the front housing for electrical termination to corresponding header contacts;
a first ground shield coupled to the first side, the first ground shield being electrically connected to the conductive holder, the first ground shield having grounding beams extending forward of the conductive holder into the front housing for electrical connection to corresponding header contacts of the header assembly, the first ground shield having ground skewers extending into the conductive holder and the frame assembly; and
a second ground shield coupled to the second side, the second ground shield being electrically connected to the conductive holder, the second ground shield having grounding beams extending forward of the conductive holder into the front housing for electrical connection to corresponding header contacts of the header assembly, the second ground shield having ground skewers extending into the conductive holder and the frame assembly, the ground skewers of the second ground shield engaging and being electrically connected to corresponding ground skewers of the first ground shield.

17. The electrical connector assembly of claim 16, wherein the ground skewers of the first ground shield are spring biased against the ground skewers of the second ground shield.

18. The electrical connector assembly of claim 16, wherein the ground skewers create an electrical path between the first ground shield and the second ground shield.

19. The electrical connector assembly of claim 16, wherein the ground skewers are disposed between the contacts.

20. The electrical connector assembly of claim 16, wherein the first ground shield includes a main body, the ground skewers being stamped and formed out of the main body leaving elongated windows in the main body, the windows being elongated in a direction parallel to the contacts.
